(19) United States
(12) Patent Application Publication
(10) Pub. No.: US 2005/0125308 A1
(43) Pub. Date: Jun. 9, 2005

(54) Automatic template-based e-commerce system and method of implementing the e-commerce system

(75) Inventors: Jose Puentes, Hollywood, FL (US); Bernard Gutman, Hallandale Beach, FL (US)

Correspondence Address: LERNER AND GREENBERG, PA, P O BOX 2480, HOLLYWOOD, FL, 33022-2480, US

(73) Assignee: Pricester.Com, Inc.

(21) Appl. No.: 10/988,747

(22) Filed: Nov. 15, 2004

Related U.S. Application Data
(60) Provisional application No. 60/527,873, filed on Dec. 8, 2003.

(51) Int. Cl. G06F 17/60

(52) U.S. Cl. 705/26

(57) ABSTRACT

A method of operating an e-commerce shopping system includes providing a network host computer hosting a plurality of websites from vendors selling products and/or services. The network host computer receives an information request from a customer who wishes to shop online in the e-commerce shopping system. A community search, via a community search engine hosted on the network host computer, is ran for matching the information request of the customer with identified goods and/or services. The customer is directed to at least one of the websites containing the requested information existing within the e-commerce shopping system.

### CROSS-REFERENCE TO RELATED APPLICATION

This application claims the benefit under 35 U.S.C. § 119(e) of provisional application No. 60/527,873, filed Dec. 8, 2003.

### BACKGROUND OF THE INVENTION

### Field of the Invention

The present invention relates to online e-commerce platforms and particularly to a distributed and centralized model of an automated template-based system that enables the quick development of websites to give users an online presence on the Internet.

Reverse auctions are fixed-durations bidding events hosted by a single buyer, where multiple suppliers compete for business. Typically, a consumer sends an online request for a product or a service, and receives replies from various suppliers. The consumer then chooses the best deal. The consumer benefits by saving time and money. However, the supplier does not always benefit. Suppliers are sometimes forced to offer low-cost cost products and services quickly, so quality could suffer. Further, suppliers generally do not have the technological capabilities or time to customize and host their own website, or to manage a comprehensive on-line sales or auctions, in order to obtain the full benefits of the Internet.

The underlying principle of a reverse auction is the need to provide consumers with information about products and/or services of suppliers. This is typically done via the website of the supplier. It is desirable to provide suppliers with a system that allows their product or service database to be easily accessed by consumers without putting a strain on their hardware resources. Further, given the one-dimensional nature of typical on-line reverse auctions, suppliers would greatly benefit from the ability to barter directly with a consumer via a two-way instant messaging chat system, to keep track of customer sales and shipping information, to create and customize their own websites via a variety of website templates, and to receive additional customers through use of an on-line consumer lead generation program.

U.S. Pat. No. 6,009,413 to Webber et al. describes a real time shopping system in which individual retailers send information regarding their products to a central database. The central database stores information relating to items for sale from various retailers. A potential customer dials in to the central database and requests a particular item. The central database searches its records from the various retailers and provides the customer with information on the requested product from the various retailers. More specifically, the central database formulates a page showing the requested product from the various retailers and forwards the page to the user for review and purchase. However, this system does not let the individual retailers to present their products individually or to control the form of the presentation. In addition, there is no way for the individual retailer to communicate with the customer.

### SUMMARY OF THE INVENTION

It is accordingly an object of the invention to provide an automatic template-based e-commerce system and method of implementing the e-commerce system that overcomes the above-mentioned disadvantages of the prior art methods and devices of this general type.

With the foregoing and other objects in view there is provided, in accordance with the invention, a method of operating an e-commerce shopping system. The method includes providing a network host computer hosting a plurality of websites from vendors selling products and/or services, receiving, through the network host computer, an information request from a customer, and running a community search using a community search engine hosted on the network host computer for matching the information request of the customer with identified goods and/or services. The customer is then directed to at least one of the websites containing the requested information existing within the e-commerce shopping system. In this manner, a shopping mall is presented in an e-commerce format in which the vendors are charged for various services provided by the shopping mall.

The invention provides an Internet portal that allows consumers to browse and search online for products and services. The Internet portal also allows consumers to browse through a category based web directory. Consumers can purchase items from storeowners, bid on auctioned items, post reverse auctions, place classified ads, participate in a bartering/trading community or request quotes from other members that provide products or services. The main function of the invention is to provide a community search engine and a point server which locates and redirects products, services and/or customers throughout an online e-commerce platform, whether locally hosted on the Internet portal, on a distributed client within the portal, or through child portals and down through their hosted or distributed communities to requesting customers. Vendors can link their existing websites with other hosts and will be indexed and redirected by the network search engine. Consumers can search for service providers and are directed to participating vendor/members site where they will see a button, image or banner promoting the discounts or bonus items of service providers. Consumers can also search through a directory of discount or bonus items (also known as coupons). The invention provides additional features that allow suppliers to create custom websites, and to interface directly with potential or actual customers in order to obtain a greater and more aggressive online presence.

Other features which are considered as characteristic for the invention are set forth in the appended claims.

Although the invention is illustrated and described herein as embodied in an automatic template-based e-commerce system and method of implementing the e-commerce system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, illustration of a network for implementing an e-commerce based system according to the invention; and

FIGS. 2-7 are flow charts diagramming different web modules for illustrating services available from the e-commerce based system.

### DESCRIPTION OF THE PREFERRED EMBODIMENTS

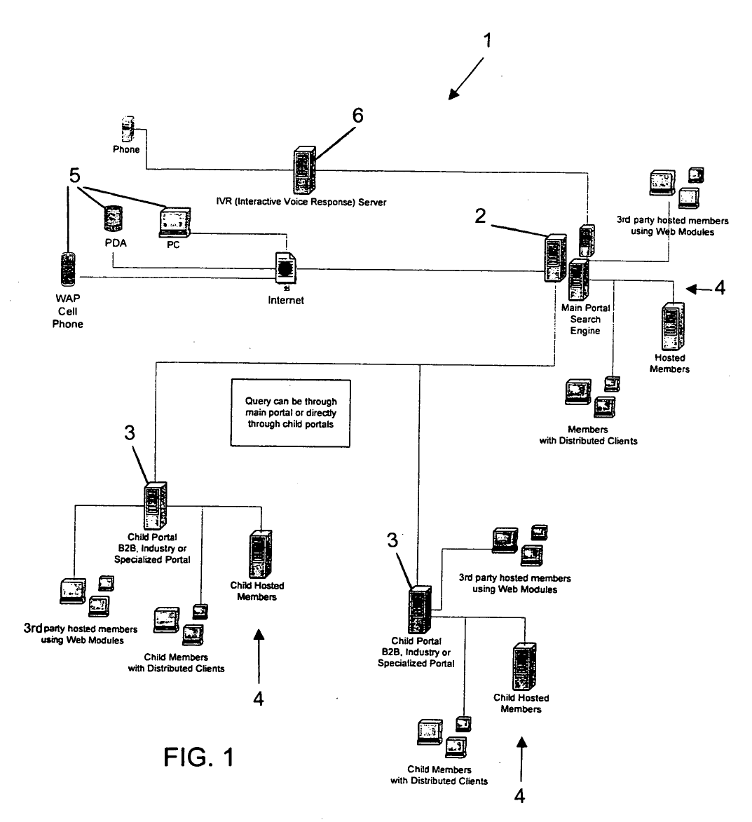

Referring now to the figures of the drawing in detail and first, particularly, to FIG. 1 thereof, there is shown a centralized e-commerce network 1 that includes a distributed hybrid system formed of peer-to-peer and centralized components. The invention establishes a universal evolutionary network to transparently facilitate information to vendors/members 4 and to provide a standard mechanism by which information providers can be dynamically connected and/or assimilated to the network 1. The information can be, for example, product pricing information, product detail information, advertising, business or personal information, but not limited to any data structure or content.

The system of the invention allows a vendor/member 4 to dynamically plug in their product or information databases without interfering with the current data of the system 1. Links are supported so that vendors/members 4 can provide access to their data without having to upload the actual data to a centralized portal or network 2. Because the network 1 has the centralized network or portal 2, it does not require the vendor/member 4 to run their own distributed peer-to peer web server network.

The e-commerce portal of the invention allows for on-the-fly creation of virtual portal child sites that are standalone in appearance, but are (optionally) part of an aggregate site that includes it's own content as well as all child site content. The child sites 3 are fully functional as the primary portal and can communicate with their own communities. This configuration is ideal for business-to-business (B2B), industries, and countries.

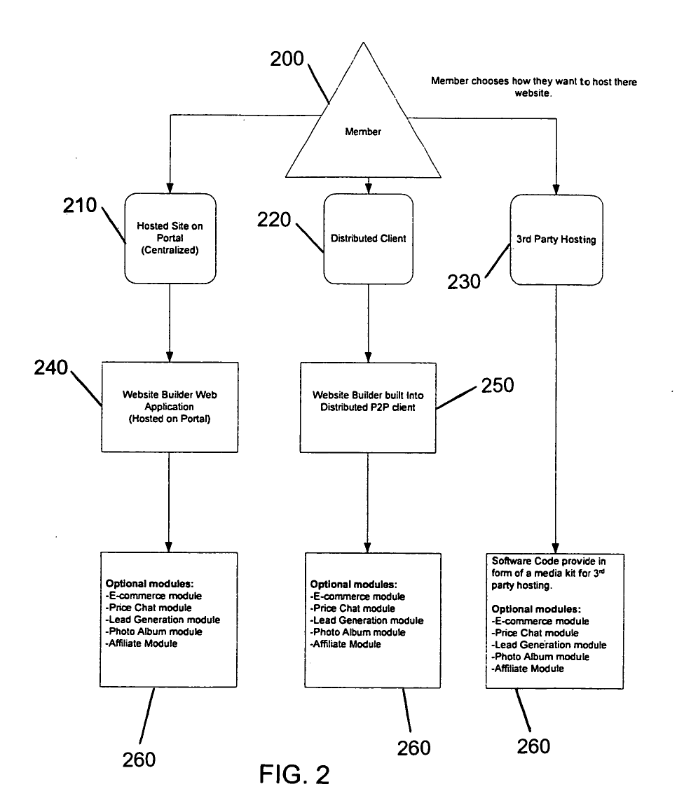

As shown in FIG. 2, another feature of the invention is the incorporation of a website builder subsystem. Vendors/members, step 200, can create automated sites on their peer-to-peer distributed client, step 220, on the centralized portal, step 210, or as 3^{rd} party hosted members, step 230. The present invention provides vendors/members with the ability to build their own websites, whether personal, retail, or service related, using pre-designed templates further customized by font and color entries and connect their own hosted sites to the centralized portal 2 or to be directly hosted on the centralized portal 2, steps 240 or 250.

The websites can include optional modules as shown in step 260 for all of the options.

In one embodiment of the present invention, a member 4 can build their own personal website including such features as personalized design-oriented templates. The members 4 are provided with the ability to customize pages including a Home, About, Contact and Privacy Statement pages and custom named pages, they can add titles, logos and images to their web pages, as well as add keywords in order to assist search engine crawlers to find keywords in mega tags. Banners can be displayed on a template of the member 4, which act as a dynamic window to allow the portal to control the content being displayed. Consumers or users 5 can visit the website/store of the member 4 by typing the appropriate URL, for example, membername.portal.com or portal.com/membername.

Personalized domains can be forwarded to this address through domain forwarding or by directing the domain to the portal name servers.

In another embodiment, the present invention allows a member 4 to build a retail/e-commerce enabled website. In addition to the features provided for the personal website of the member 4, all of the items of the member, whether products, services or classifieds, indexed through the host portal will appear in the website/store of the member 4. Consumers 5 can reach these personalized sites by following the searches from the portal search queries to the store positioned for the sale in the shopping cart of the member 4. The website builder also allows entry for payment and shipping detail page. An “Order Status” button on the homepage of the member 4 allows their customers 5 to track their purchases. Members (Vendors) 4 can preview their items in their store by the categories they have listed and the customers can choose to sort by type, auction, barter, classified, fixed price or all or any combination of these parameters/features. The member 4 may be billed monthly at an additional fee for the use of this custom site.

Vendors 4 may also tie in their preferred merchant payment system. A transaction fee for the vendor 4 may apply for using the portal/network search results to acquire a deal/facilitate the sale. Merchant payment fees are billed separately.

The retail sub-system of the invention allows the member/vendor 4 to define shipping fee rules and/or integrate with 3^{rd} party shippers/carriers for automated shipping calculations. Each vendor/member 4 has a transaction manager that tracks their sales, shipping status and payment status. Retailers can optionally add a discount or bonus coupon with a value that can be deducted or applied to their orders.

In still yet another embodiment, the present invention provides a template for members to build service websites. These templates are geared for the service provider that normally has little or no online sales, for example roofers, lawyers, and auto service centers. This feature has an option to allow item listing support similar to that of the retail website builder. An added feature in the service website builder is one that requires the member 4 to add some type of discount or rebate for their visiting customers and to classify the category of service they provide.

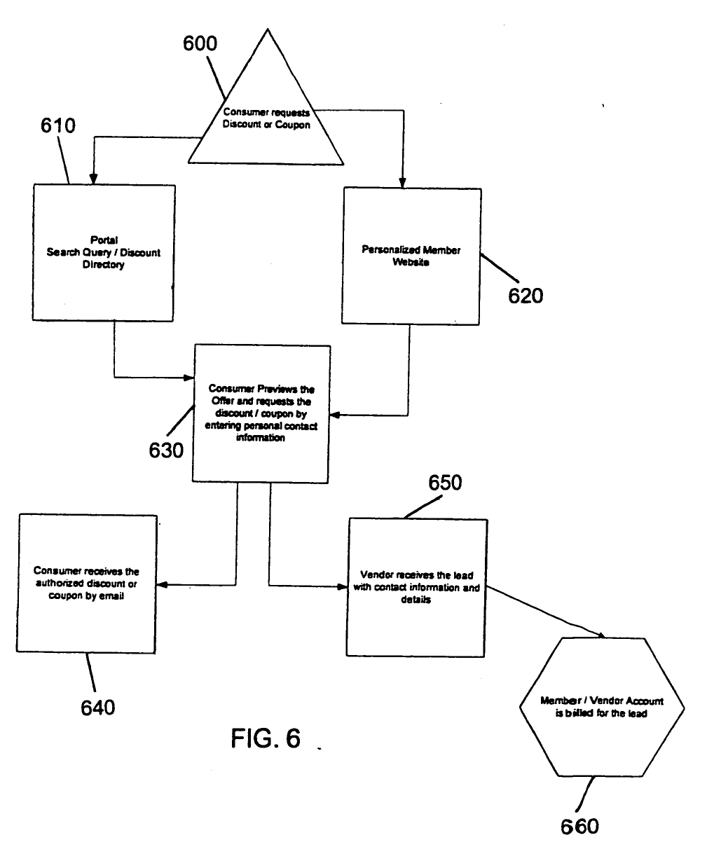

Incorporated in this embodiment is a lead generation feature. In this feature, a lead fee is based on the category of the item listed. The member/vendor is prompted with an option to agree on a predetermined price per lead that they will be charged when a referral has been collected and delivered to their e-mail. The referral is considered to be a lead when a potential client receives an authorized discount or bonus by e-mail that was provided by the host service provider. To indicate or advertise the presence of a lead generation feature, the template will include a button, banner or other activation image on the homepage of the vendor site or through a search query or directory browse, which identifies the presence of a discount upon activation of the image, for example, the words “Click here to receive bonus/discount”, see FIG. 6, step 600. When a customer clicks on this image the system queries the discount directory, step 610, and then goes to the details of the bonus/discount and an online form to fill out, step 630.

They can then sign up as a customer of the system to receive benefits provided by the system. The customer enters their contract information such as their address, phone and e-mail on the form. Once the customer confirms the authenticity of the information, an e-mail is sent to the customer with the bonus/discount details attached, step 640. An e-mail is also sent to the vendor with the information about the lead, step 650, and a fee is charged to the account of the vendor/member, step 660. Subsequently, the host network applies a charge to the vendor/member account equal to the amount of referral fee for the lead. While this feature was created to satisfy a need in the online service industry it is not limited to service providers and can used for offering discounts and promotions for product related items.

In the alternative, a customer may click on the image to receive the bonus/coupon in the personalized member website, step 620. In this manner, such discounts and coupons can be personalized for an individual vendor rather than on a generic coupon page provided by the portal.

The system and method of the present invention allows for the member to build a website that is hosted and maintained by the e-commerce host as well as allowing the member to build a “distributed” website, i.e. one that is stored on the computer of the member. The former allows the member to upload their customized websites to the host via file transfer protocol(FTP) while integrating the payment and marketing tools of the host into the site of the member. Personalized domain names can be pointed to the particular store and e-mail accounts will also be hosted.

The distributed website builder option allows any member to host their own website, email system and/or vendor system on their own computer using an application/client. The application or client is a web server that communicates directly through the Internet and communicates with the host network. The system allows members to manage their customized content on their own computers while integrating the portals e-commerce components and shopping network, payment configuration and marketing tools into the site of the member. Payment transaction are directed to the portals centralized server under SSL 128 bit encryption or handled by a secure 3^{rd} party merchant payment system.

The web servers do not require a static Internet Protocol (IP) because they update their IP to a centralized server, which stores their location into database. An update is sent by the peer-to-peer (P2P) client notifying the host network of it's current IP address. When a consumer or visitor is linked through a query from the host network or through a redirect from a page call to the site of the member, the dynamic domain name system (DNS) of the host network will redirect the customer to their P2P web server.

Personalized domain names can be pointed to the particular store and e-mails can also be hosted by the client of the member. Consumers can access the website of the member by typing in the associates URL. The system of the present invention also includes real time inventory control and supports automated order processing components. This is done through XML communication through 3^{rd} party accounting systems. The inventory control features allows for accurate inventory adjustments when there is an online sale. The automated processing components can be linked to suppliers to replenish inventory that has been exhausted.

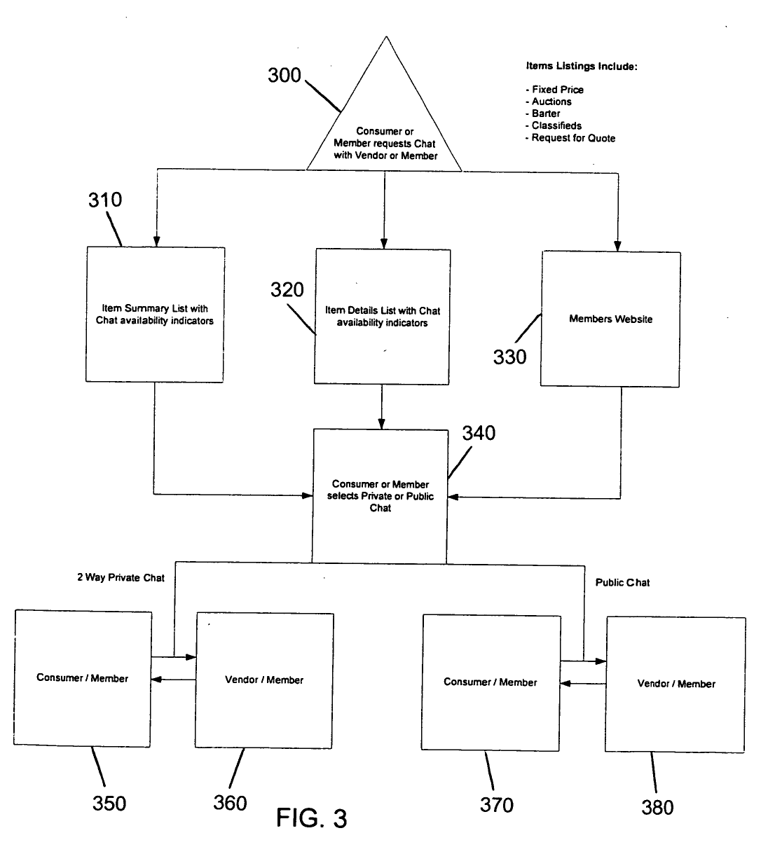

In a further embodiment shown in FIG. 3, the method and system of the present invention offers a two-way instant messaging system or “chat” system that is used to communicate between customers and vendors. In this fashion, a consumer 5 can interface directly with a vendor/member 4 if the vendor 4 is on line, and discuss details about the item or service being offered, step 300. Preferably, the chat service is web-based so that the consumer 5 does not need to install any application on his or her computer. This system allows vendors/members 4 to chat when they each have the web-based chat client active or the windows desktop chat application active, steps 310-330.

The vendor/member 4 can elect to allow public chats and or private chat conversations, step 340. Public chats are when all chat parties can preview everyone's conversations, steps 370, 380. This feature is beneficial for a listing (auction/barter/reverse auction, etc.) that expires at a given time and the vendor cannot speak to each party individually because of the limited time.

A private chat is when each chat party speaks to the other party privately and the other parties cannot see the communication, steps 350, 360

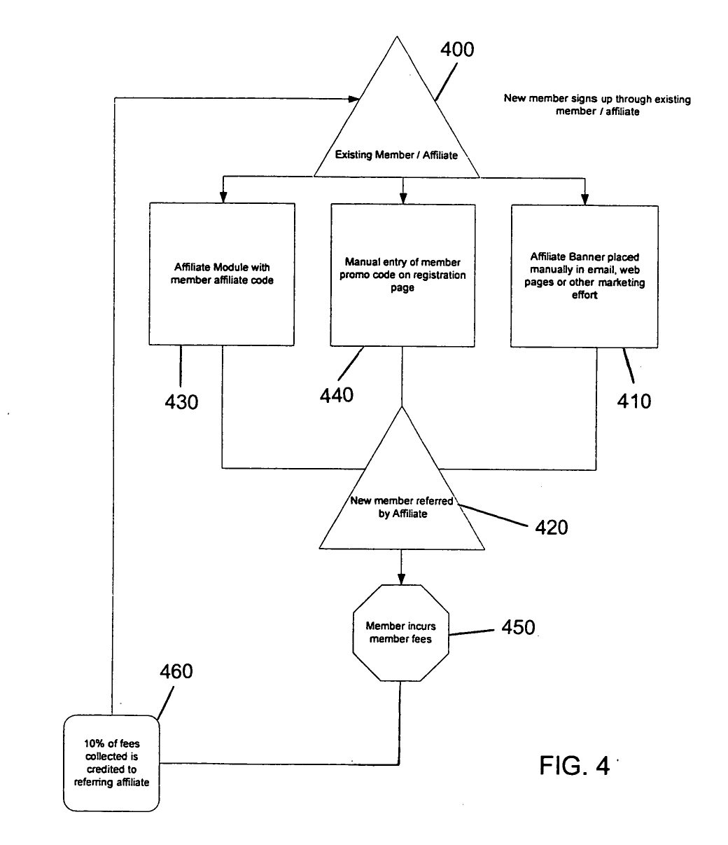

In yet another embodiment, the present invention includes an “Affiliate System”, step 400. This feature provides an optional image, such as a banner or logo that is displayed on the on-line website of the store or other page which the member designates, for example, “Get your own Website/Web store” logo 410. When a consumer/visitor clicks that logo, they are taken to a registration page, which has a short description of benefits and invites the consumer to register in order to have access to their own online website/web store. A link is provided that explains the Affiliates System and allows members to get hyperlinks and banners to promote the site of the host to other users. In this manner new members are signed up, step 420. Of course other methods of advertisement are also shown in FIG. 4, see steps 430, 440. Members pay a fee for using fee based services on the portal including, transaction fees, banner fees, promotional item fees, etc., step 450. When a new member, makes a payment on their account, a credit of 10% of the payment is applied to the affiliate account that referred that member's account, step 460.

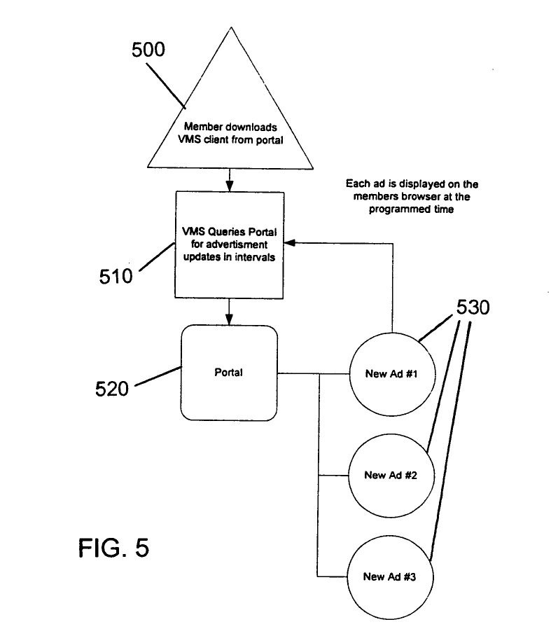

The invention further includes a virtual marketing system that can be promoted either by CD presentation, direct e-mail marketing, member registrations or packaged along with other downloadable tools, as shown in FIG. 5, step 500. This feature, once installed, resides silently on the computer of the member. When there is an Internet connection available, the system of the present invention queries an online database for scheduled advertisement campaigns created by the host or a host affiliate, step S10. The advertisement campaigns are web-based Hyper Text markup Language (HTML) pages and can be scheduled by time and date using an online management interface. The system resembles the “pop-up advertisements” that are so commonly used. However, because the timed advertisements originate from the host site and not from an Internet script, they are immune from pop-up blockers and fire walls. At the given time and date, the portal posts the identified ad, steps 520-530.

The system members that accept this option upon sign-up or after installing a service or application, will be cross-referenced in the database and can become part of the e-commerce host's marketing campaign list or used for the host member's marketing efforts. For example, the host would provide it's members with Customer Relationship Management (CMR) tools in their upgraded sites to allow members to send marketing campaigns to their previous customers. These campaigns include promotions, newsletters, updates and even intelligent suggested items (products and services) based on their customers' previous purchasing habits.

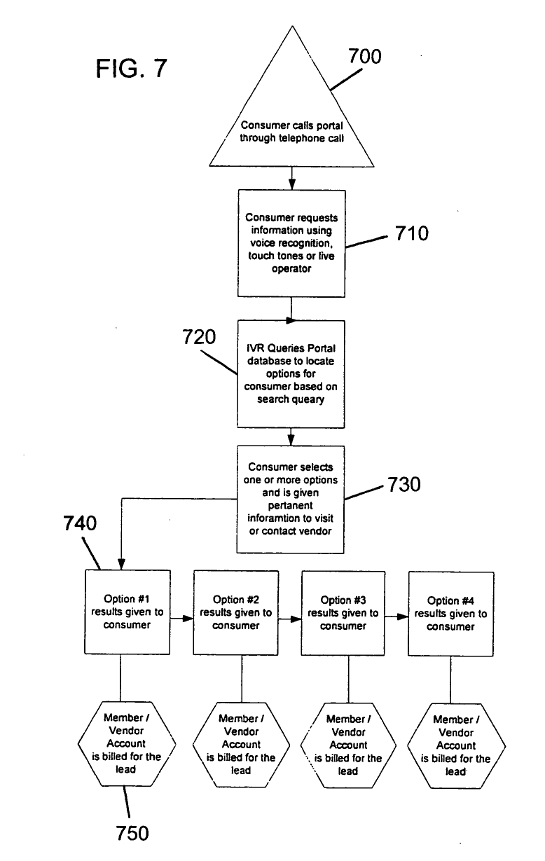

Another feature, shown in FIGS. 1 and 7, utilizes an interactive voice response (IVR) server 6 to receive telephone queries to the portals database. Consumers 5 can call the host services via telephone, step 700, and request searches for products and services in their geographic regions through the IVR server 6 or a live operator, step 710. The IVR server 6 can be configured to query the main portal 2 or the child portals 3, steps 720. Consumers 5 can also enter item bar codes or other manufacturer or business codes and request information about a specific item. The consumer is given options relating to available vendors selling the selected product or service given in the order of geographic location and bid rank, step 730. The customer then chooses more information for the 1^{st} listing with the option of another listing, then another and so on, step 740. Preferably, the options are given serially. An agreed fee for the referral is charged to the vendor or vendors that were referred to the consumer, step 750. There are no listing fees only referral fees. These fees are structure in a highest to lowest bid option where different vendors are presented to the consumer based on their bid rank and geographical area.

A series of Web Modules allowing the integration of features to be added to sites that are hosted with a portal, distributed hosted site or 3^{rd} party hosted site. These modules or add-ons provide information and interaction from the main or child portals content to the visitor of the website. This feature is built into the website manager or distributed client allowing a member to add the modules they require for their sites. Example: Web store module (Fixed price items, Auction, Barter/Trade, Classifieds, Request for Quote), Price Chat modules, Lead Generation module, Photo Album module, Affiliate marketing module.

This feature is also provided in a media kit that allows 3^{rd} party web developers or webmasters to easily add the code and provide the use of the modules on any site not limited to portal hosted or distributed client sites.

Web Store Component—This module allows the integration of an e-commerce system to be added to the website which includes the ability to display listed items such as (fixed price items, auction, barter/trade, classifieds, request for quote) and to allow the consumer to bid or purchase the items through an electronic shopping cart which integrates to a 3^{rd} party payment system.

Price Chat Module—This module allows the integration of a chat system to be added to the website which allows 2 way private communication with consumers as well as communication through a public chat room designated to each member/vendor.

Lead Generation Module—This module places a discount/coupon option on the member site allowing the member to distribute discounts/coupons to consumers and collect the interested consumers contact information for follow up.

Photo Album component—This module allows the integration of a photo album on the members site. With this module a member can upload business or personal photos to display to their visitors.

Affiliate Marketing component—This module automatically places a choice of banners on a members site allowing the member to promote and receive credit for signing up new members.

1. A method of operating an e-commerce shopping system, which comprises the steps of:
providing a network host computer hosting a plurality of websites from vendors selling products and/or services;
receiving, through the network host computer, an information request from a customer;
running a community search using a community search engine hosted on the network host computer for matching the information request of the customer with identified goods and/or services; and
directing the customer to at least one of the websites containing the requested information existing within the e-commerce shopping system.

2. The method according to claim 1, which further comprises:
providing a portal child computer hosting further websites from further vendors selling products and/or services, the portal child computer being connected to and communicating with the network host computer; and
directing the customer to at least one of the websites or the further websites containing the requested information as determined by the community search engine, the community search engine providing a website directory for browsing listed websites, and/or a product/service director for browsing available products and services.

3. The method according to claim 2, which further comprises:
hosting a website builder subsystem on at least one of the portal child computer and the network host computer for building the websites and the further websites.

4. The method according to claim 3, which further comprises for each of the vendors and the further vendors:
customizing the respective websites using pre-designed templates provided by the website builder subsystem; and
injecting keywords in the respective websites for assisting the community search engine.

5. The method according to claim 4, which further comprises displaying banners on the websites and the further websites.

6. The method according to claim 3, which further comprises:
providing the websites and the further websites with a centralized payment center service and a shipping center service hosted on at least one of the child portal computer and the network host computer; and
providing the websites and the further websites with an order tracking system service for allowing the customer to track purchases.

7. The method according to claim 3, which further comprises:
providing a transaction manager service for tracking sales, carrier fees, shipping fees and transaction fees for each of the vendors and the further vendors.

8. The method according to claim 3, which further comprises:
providing discount offers on the websites and the further websites for advertising reduced prices for goods and services.

9. The method according to claim 8, which further comprises:
requesting customer information upon actuation of a discount offer;
requesting authenticity of the customer information resulting in a generation of a lead upon completion of the authenticity step;
releasing the discount offer to the customer;
providing the customer information to a given vendor; and
charging the given vendor for the lead.

10. The method according to claim 9, which further comprises:
generating an activation image on a home page of the given vendor to indicate an existence of the lead.

11. The method according to claim 9, which further comprises signing up the customer on a notification system of the given vendor to receive notices of future discounts or when price points have been met.

12. The method according to claim 3, which further comprises:
allowing the hosting on at least one of the portal child computer and the network host computer of an individual vendor running a customized website not formed by the system website builder subsystem; and
transmitting communications between the portal child computer and the network host computer for updating search information and available product and service information.

13. The method according to claim 12, which further comprises uploading the customized website to the network host computer and integrating payment, shipping and marketing service tools provided by the network host computer or the child portal computer.

14. The method according to claim 3, which further comprises providing real time inventory control services and automated order processing services to the vendors and the further vendors.

15. The method according to claim 14, which further comprises providing automatic reordering services to the vendors and the further vendors when the real time inventory control services determine that a product is low.

16. The method according to claim 3, which further comprises providing a-two-way instant messaging service used for communications between respective vendors and respective customers.

17. The method according to claim 16, which further comprises providing the two-way instant messaging service as a web-based messaging service.

18. The method according to claim 17, which further comprises setting up the two-way instant messaging service for allowing both private communications and public communications.

19. The method according to claim 18, which further comprises using the public communications for providing a service selected from the group consisting of an auction service, a barter service session, a fixed price service, and a reverse auction service.

20. The method according to claim 19, which further comprises running the service for a given time duration.

21. The method according to claim 2, which further comprises advertising on the websites and the further websites the availability and details of the e-commerce shopping system and inviting customers to open their own web-based store resulting in a system store affiliate.

22. The method according to claim 21, which further comprises paying a commission fee, to a given vendor responsible for attracting the system store affiliate, for all sales obtained by the system store affiliate.

23. The method according to claim 2, which further comprises implementing a virtual marketing service on at least one of the network host computer and the portal child computer, and when there is an Internet connection available, the virtual marketing service queries an online database for scheduled advertisement campaigns and displays an advertisement on a respective vendors Internet browser or a computer screen of the customer.

24. The method according to claim 23, which further comprises generating pop-up advertisement on the websites and the further websites, the pop-up advertisements originating from the network host computer and therefore being immune to pop-up blockers and fire walls.

25. The method according to claim 24, which further comprises:
uploading advertisements from the vendors and the further vendors and incorporating the uploaded advertisements into the virtual marketing service; and
charging for the uploaded advertisements.

26. The method according to claim 1, which further comprises:
providing an interactive voice response system which communicates with the network host computer;
receiving telephone inquiries from customers and related product and/or service requests;
matching the product and/or services requests to given vendors;
providing the customers with a choice to be directly forwarded to the given vendors or be given a name and information relating to the given vendors and the products and/or services; and
charging the given vendors, respectively, for each customer referred to a given vendor.

27. The method according to claim 26, wherein the customers enter at least one of bar codes and products codes as part of for the related product and/or services requests.

28. The method according to claim 26, which further comprises allowing the respective vendors to bid on the customers in order to have a given customer forwarded to a given vendor.

29. The method according to claim 1, which further comprises providing a web directory for browsing by the customer on the network host computer for identifying available websites, available products, and available services.

30. An e-commerce shopping system, comprising:
a network host computer hosting a plurality of websites from vendors selling products and/or services, said network host computer programmed to:
receive an information request from a customer;
run a community search using a community search engine for matching the information request of the customer;
allowing the customer to browse a community web directory; and
directing the customer to at least one of said websites containing the requested information existing within the e-commerce shopping system.

31. The e-commerce shopping system according to claim 30, further comprising:
a portal child computer hosting further websites from further vendors selling products and/or services, said portal child computer being connected to and communicating with said network host computer, said portal child computer programmed to direct the customer to at least one of the websites or the further websites containing the requested information as determined by said community search engine.

32. The e-commerce shopping system according to claim 31, wherein said network host computer is further programmed to run a website builder program for building the websites and the further websites.

33. The e-commerce shopping system according to claim 32, wherein said network host computer is further programmed for each of the vendors and the further vendors to:
custom the respective websites using pre-designed templates provided by the website builder subsystem; and
injecting keywords in the respective websites for assisting search engine crawlers/spiders.

34. A method of operating an e-commerce shopping system, which comprises the steps of:
hosting a plurality of websites for vendors selling products and/or services;
receiving an information request from a costumer;
running a community search for matching the information request of the customer with identified goods and/or services;
directing the customer to at least one of the websites containing the requested information existing within the e-commerce shopping system; and
charging the vendors for each directed customer.

35. The method according to claim 34, which further comprises:
listing a coupon page viewable to the customer identifying various coupons applying to various products and/or services from the vendors.
